(19) United States
(12) Patent Application Publication
(10) Pub. No.: US 2009/0278334 A1
(43) Pub. Date: Nov. 12, 2009

(54) Device for installing and removing a clip method for inserting and removing a cotter pin

(76) Inventors: HUGH CARR, Port Ewen, NY (US); DONALD G. FLAYNIK, JR., Channahon, IL (US)

Correspondence Address: DONALD FLAYNIK, 25208 West Reed St., P.O. Box 114, CHANNAHON, IL, 60410, US

(21) Appl. No.: 12/152,092

(22) Filed: May 12, 2008

(51) Int. Cl. B60D 1/02

(52) U.S. Cl. 280/515

(57) ABSTRACT

A device 10 for installing and removing a cotter pin or similar clip 8 includes a clip receiving end 12 for urging the clip 8 through and/or about a hitch pin, and an extraction end 14 for removing the clip 8 from the hitch pin which ultimately secures a trailer to a trailer hitch. The extraction end 14 is integrally joined to the clip receiving end 12 via an extension portion 16 that separates the receiving and extraction ends 12 and 14 a predetermined distance, thereby forming a solid and continuous member 17 with an overall length that enables an operator to install or remove the clip 8.

### BACKGROUND OF THE INVENTION

1. Field of the Invention

The present invention relates generally to installing and removing clips and, more particularly, to installing and removing cotter pins into and from a trailer hitch.

2. Background of the Prior Art

Operators of towing vehicles connect a towing member to a rear end portion of the frame of the vehicle. The operator can then connect a trailer to the towing vehicle by inserting a hitch pin (generally cylindrical) through aligned apertures in the towing member and trailer. The hitch pin is then locked in place via a cotter pin or similar clip well known to those of ordinary skill in the art. The cotter pin includes one leg that perpendicularly inserts through an aperture in the hitch pin, and a second leg that “wraps” radially about one-half (180 degrees) the circumference of the hitch pin such that an angle portion in the second leg “locks” the cotter pin in place.

The cotter pin is installed or removed by an operator grasping an end portion of the cotter pin with his or her fingers, then forcibly pushing or pulling the end portion of the cotter pin until the legs of the cotter pin engage or are removed from the hitch pin. The problem with installing or removing clips such as cotter pins is that the operator will often experience “pinched” or otherwise injured fingers due to the force required to overcome the “gripping” of the second leg of the cotter pin upon the hitch pin as the cotter pin is inserted upon or removed from the hitch pin.

A need exists for a device that forcibly urges a cotter pin upon or forcibly removes the cotter pin from a hitch pin via one end, while an operator's hand grasps an opposite end of the device, thereby disposing the operator's hand a predetermined distance from the cotter pin to prevent the operator's fingers from being injured.

### SUMMARY OF THE INVENTION

It is a principle object of the present invention to provide a device for installing and removing a cotter pin or similar clip through an aperture in a hitch pin and/or to position the cotter pin about the hitch pin. A feature of the device is a clip receiving end for urging a clip through a hitch pin for a trailer hitch. Another feature of the device is that the clip receiving end includes an engagement portion configured to forcibly engage an end portion of the clip. Yet another feature of the device is that the clip receiving end includes a pair of side plates. An advantage of the device is that the side plates snugly receive the end portion of the clip therebetween, thereby maintaining engagement between the engagement portion of the clip receiving end and the end portion of the clip while the clip is manually urged through and about the hitch pin.

Another object of the present invention is to provide a device that includes an extraction end. A feature of the device is that the extraction end includes a “hook” configuration for grasping the end portion of the clip. An advantage of device is that the extraction end easily removes the clip from the hitch pin via an aperture in the end portion of the clip.

Yet another object of the present invention is to provide a device that includes an extension portion. A feature of the device is that the extension portion separates the clip receiving end and the extraction end of the device a predetermined distance. An advantage of the device is that the separated clip receiving and extraction ends allow an operator to grasp either end while directing the other end to install or remove the clip relative to the hitch pin.

Still another object of the present invention is to provide a device that allows the distance separating the clip receiving end and the extraction end to be adjustable. A feature of the device is an extension portion with an adjustable length. Another feature of the device is that the adjustable length is ultimately “fixed” via a manually rotated set screw. An advantage of the device is that an operator is able to manually position the device ends such that he or she is able to install or remove the clip without difficulty.

Another object of the present invention is to provide a device that is easily grasped by an operator. A feature of the device is clip receiving and extraction ends formed into handle configurations. An advantage of the device is that either end may be grasped by the operator without injury and easily manipulated such that the opposite end either installs or removes the clip from the hitch pin.

Briefly, the invention provides a device for installing and removing a clip through a hitch pin comprising a clip receiving end for urging a clip through a hitch pin for a trailer hitch, said receiving end comprising an engagement portion configured to forcibly engage an end portion of the clip; and means for maintaining engagement between said engagement portion and the end portion of the clip; and an extraction end for removing the clip from the hitch pin, said extraction end being secured to said clip receiving end.

The invention further provides a cotter pin insertion and removal device comprising means for inserting a cotter pin into a hitch pin; means for removing the cotter pin from the hitch pin; and means for adjustably positioning said insertion means relative to said removing means to allow an operator of said device to grasp said device while inserting or removing the cotter pin into or from the hitch pin.

The invention also provides a method for inserting and removing a cotter pin from a hitch pin, said method comprising the steps of providing means for receiving an end portion of the cotter pin whereby the cotter pin is ultimately urged into a hitch pin; providing means for extracting an end portion of the cotter pin whereby the cotter pin is ultimately removed from a hitch pin; providing means for manually grasping said receiving means whereby a user of the method is allowed to manually remove the cotter pin from the hitch pin; and providing means for manually grasping said extracting means whereby a user of the method is allowed to manually insert the cotter pin into the hitch pin.

### BRIEF DESCRIPTION OF THE DRAWINGS

These and other objects, advantages and novel features of the present invention, as well as details of an illustrative embodiment thereof, will be more fully understood from the following detailed description and attached drawings, wherein:

FIG. 1 is a front elevation view of a device for installing and removing a cotter pin or similar clip upon or from a hitch pin in accordance with the present invention.

FIG. 2 is a front elevation view of the device of FIG. 1, but with a pair side plates removed to expose an engagement portion of a clip receiving end of the device.

FIG. 3 is a left side elevation view of the device of FIG. 1.

FIG. 4 is an exploded perspective view of the device of FIG. 1.

FIG. 5 is a perspective view and partial phantom view of the device of FIG. 1 with an end portion of a cotter pin disposed between the side plates, and with the end portion of the cotter pin engaging an engagement portion of an engagement wall of the clip receiving end of the device, before the cotter pin is installed upon a hitch pin.

FIG. 6 is a perspective view of the device of FIG. 1 with an end portion of a cotter pin grasped by an extraction end of the device after the cotter pin has been removed from a hitch pin.

FIG. 7 is perspective view of an alternate design (hand grips included) of a device for installing and removing a cotter pin or similar clip upon or from a hitch pin in accordance with the present invention.

FIG. 8 is a perspective-phantom view of yet another design (adjustable positioning of a clip receiving end upon an extension portion) of a device for installing and removing a cotter pin or similar clip upon or from a hitch pin in accordance with the present invention.

FIG. 9 is a perspective exploded-phantom view of the device of FIG. 8.

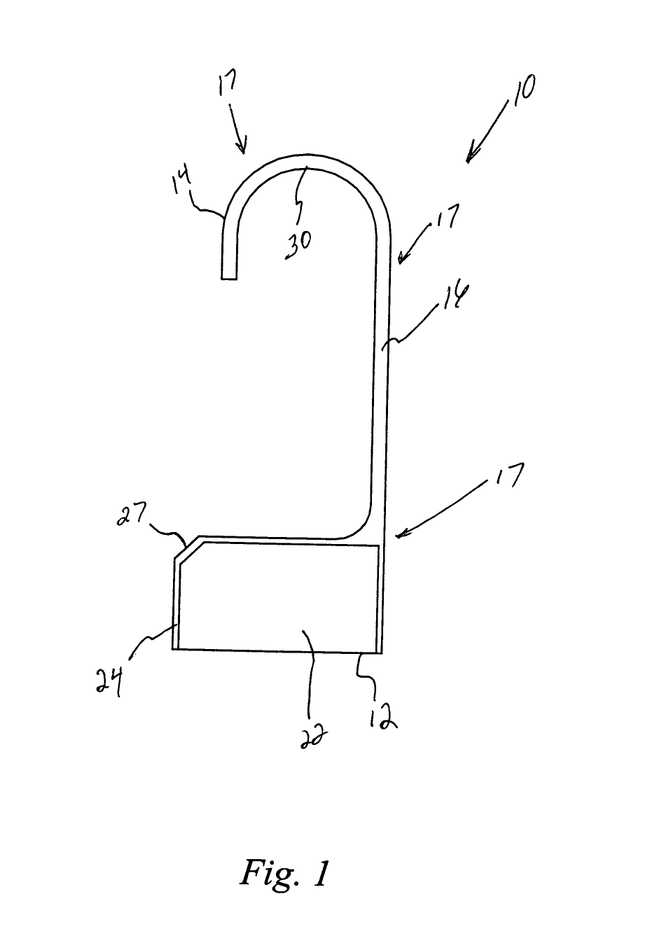

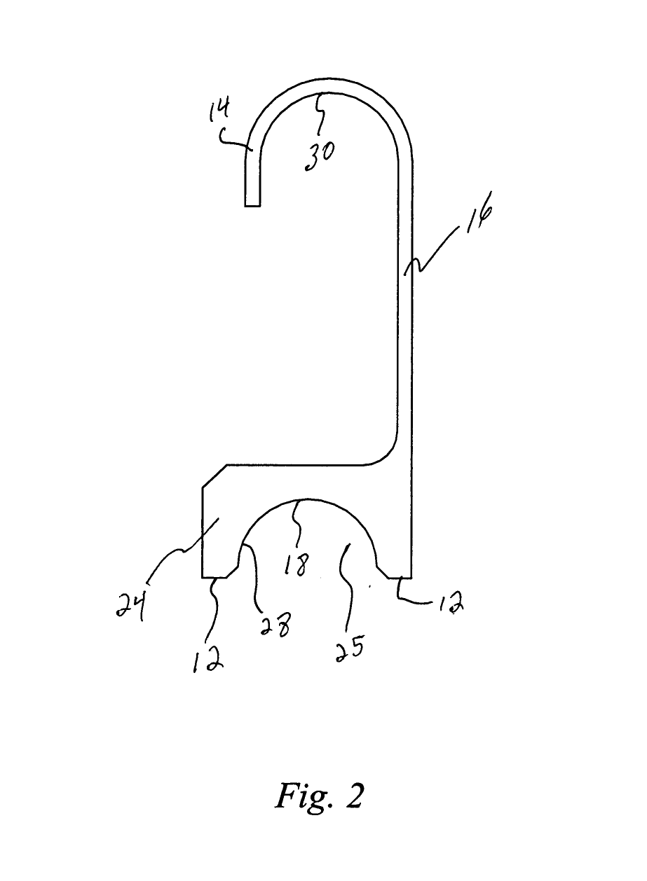

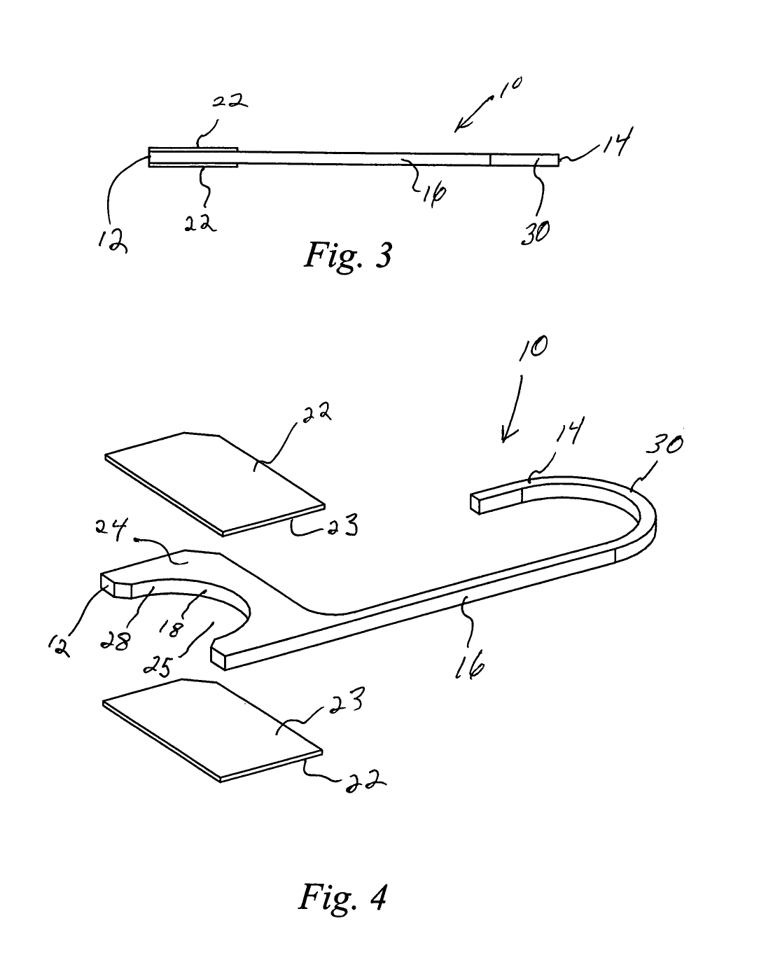

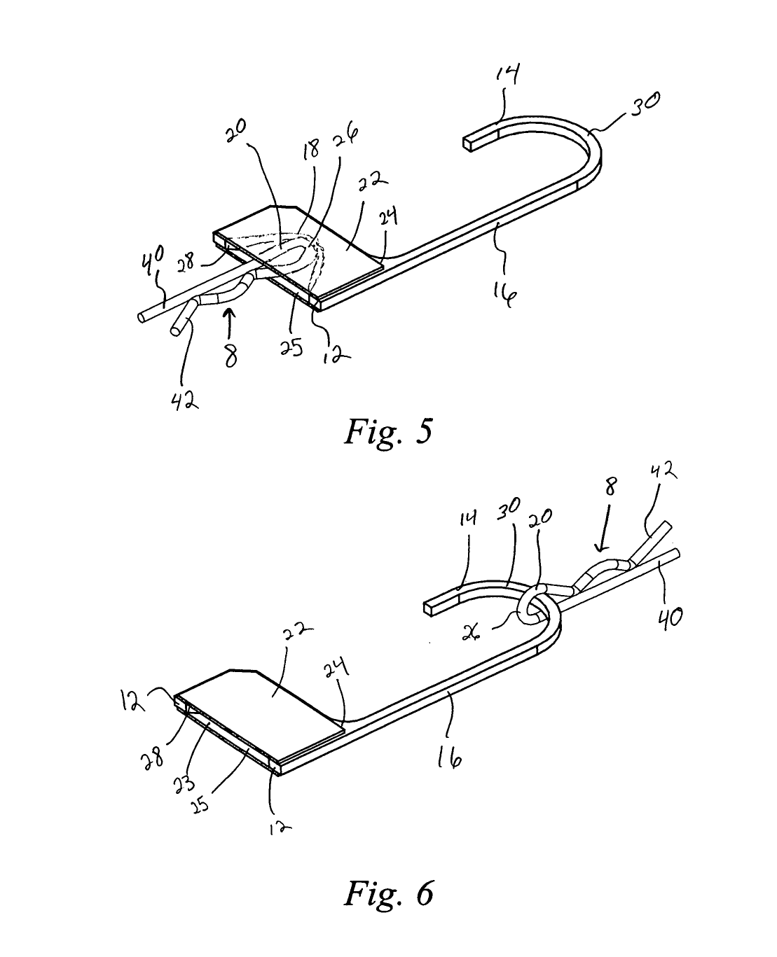

### DESCRIPTION OF THE PREFERRED EMBODIMENT

Referring now to the drawings, a device for installing and removing a cotter pin or similar clip 8 through an aperture in a hitch pin (not depicted) and/or to position the cotter pin about the hitch pin in accordance with the present invention is denoted as numeral 10. The device 10 includes a clip receiving end 12 for urging a clip 8 through and/or about a hitch pin which ultimately secures a trailer (not depicted) to a trailer hitch (not depicted) or similar towing member, and an extraction end 14 for removing the clip 8 from the hitch pin. The extraction end 14 is integrally joined or otherwise secured to the clip receiving end 12 via an extension portion 16 that separates the receiving and extraction ends 12 and 14 a predetermined distance, thereby forming a solid and continuous frame member 17 with an overall length that enables an operator to install or remove the clip 8. The frame member 17 may include a square or cylindrical cross-sectional configuration. The device 10 is fabricated from steel or similar rugged, non-deformable material capable of withstanding a relatively large quantity of manual force exerted upon either the receiving or extraction ends 14 and 16. The configurations and dimensions of the device generally correspond to the configuration and size of the clip 8 urged through the hitch pin, except that the length of the extension portion 16 is selected by an operator or user of the device 10 based upon the “reach” of the user relative to the ultimate placement of the clip 8; the selected length of the extension portion 16 promotes the clip's 8 manual insertion into and extraction from the hitch pin while the hitch pin secures the trailer to the trailer hitch.

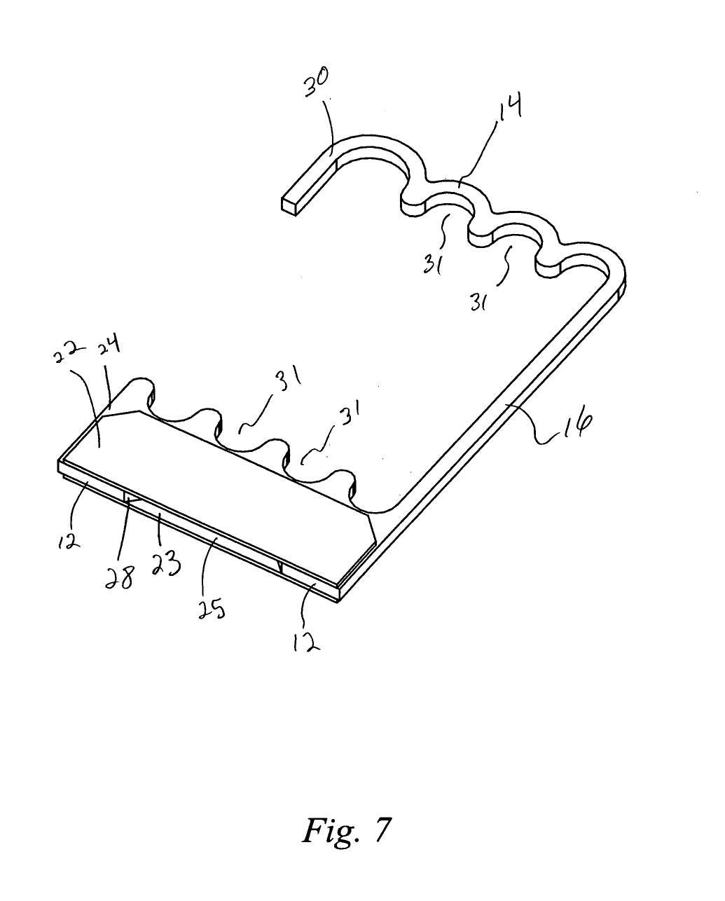

The clip receiving end 12 includes an engagement portion 18 configured to forcibly engage an end portion 20 of the clip 8, and a pair of opposite retaining side plates 22 or similar means for maintaining engagement between the engagement portion 18 and the end portion 20 of the clip 8. The clip receiving end 12 may include a handle configuration (FIG. 7) to promote the grasping of the clip receiving end 12 by an operator of the device 10. The retaining side plates 22 are secured (via welding if steel is the material of fabrication of the device 10) to cooperating member side walls 24 of the clip receiving end 12. The retaining side plates 22 are separated a predetermined distance sufficient to allow a predetermined end portion 20 of the clip 8 to snugly insert therebetween. The retaining side plates 22 are dimensioned to provide a predetermined surface area sufficient to maintain the position of the end portion 20 of the clip 8 relative to the engagement portion 18, irrespective of the quantity of manual force imparted on the extraction end 14 of the device 10 when an operator urges the clip 8 into and/or around the hitch pin. The retaining side plates 22 include planar inner walls 23 that ultimately engage the end portion 20 of the clip 8 when the end portion 20 is inserted into the recess 25 formed by the engagement portion 18. A relatively small pointed corner portion 27 has been removed to prevent an operator's hand from being scratched when grasping the clip receiving end 12.

The engagement portion 18 includes an arcuate configuration (when taking a front elevation view of the device 10) that promotes engagement between a relatively “smooth” engagement wall 28 and an outer arcuate portion 26 of the end portion 20 of the clip 8. Alternatively, the engagement portion 18 may include “V,” cylindrical or rectangular configurations, when taking a front elevation view of the device 10, that cooperate with the outer portion 26 of the end portion of the clip 8 to provide a greater surface area of engagement between the engagement wall 28 and the outer portion 26, thereby increasing the “grasp” between the clip receiving end 12 of the device 10 and the clip 8. A central groove or recess may be included in the engagement wall 28 to stabilize the position of the end portion 20 of the clip 8 as the clip 8 is manually urged into and/or about the hitch pin.

The extraction end 14 includes a “hooked,” arcuate, angular or otherwise bent portion 30 configured to promote the grasping of the end portion 20 of the clip 8, when the operator of the device 10 holds the clip receiving end 12 to ultimately extract the clip 8 from the hitch pin. The extraction end 14 may include a handle configuration (FIG. 7) to promote the grasping of the extraction end 14 by the operator of the device 10. The handle configurations for the clip receiving and extraction ends 12 and 14 include finger recesses 31 that may number one to four for each end 12 and 14 depending on the relative size of the device 10. The extraction end 14 is distally disposed relative to the clip receiving end 12 a distance sufficient to promote placement of the extraction end 14 adjacent to the clip 8 by the manipulation of the clip receiving end 12 by the hand of the operator.

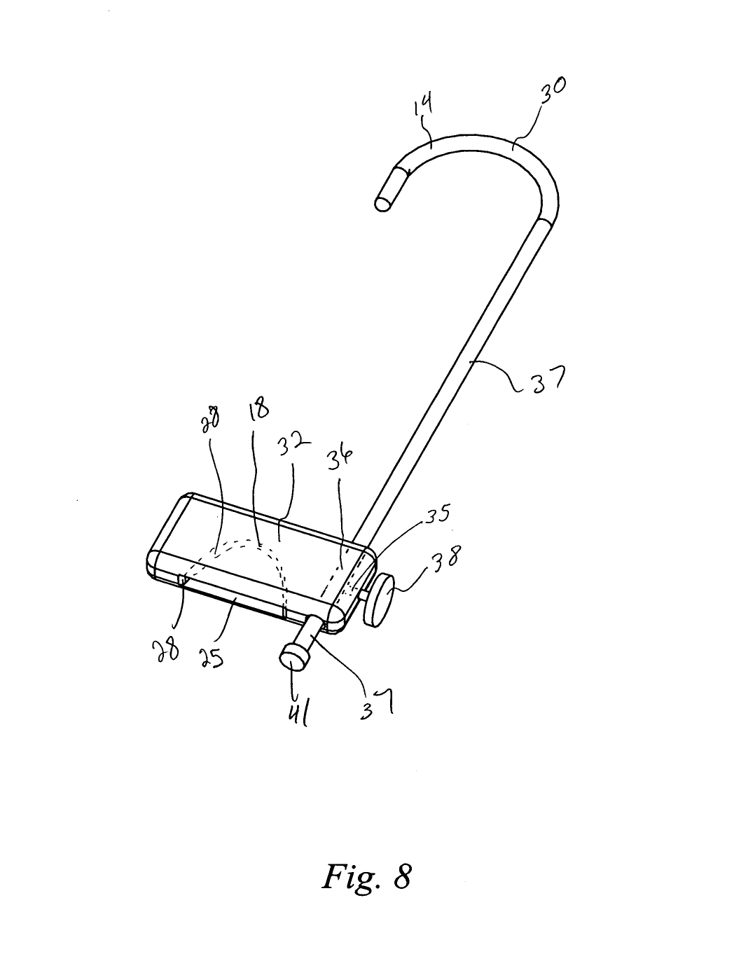

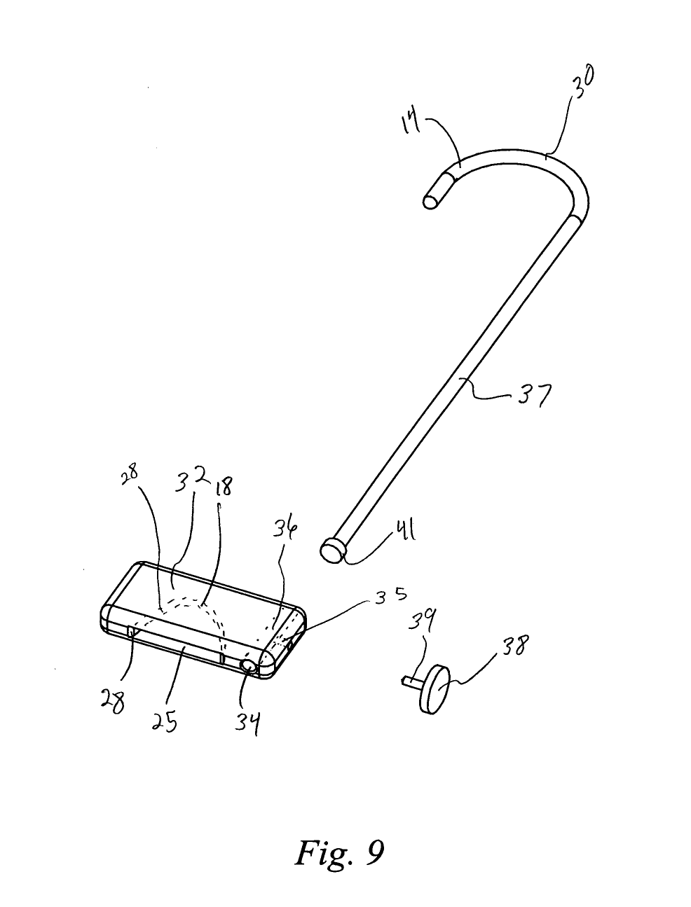

Referring now to FIGS. 8 and 9, an alternative design of the device 10 is depicted. The alternative design includes a “solid” adjustably positioned clip receiving end 32 with the same engagement portion 18, recess 25 and wall 28 as the original clip receiving end 12. The adjustably positioned clip receiving end 32 also includes an extension aperture 34 extending through an edge portion 36 of the clip receiving end 32, and a threaded set screw aperture 35. The extension aperture 34 slidably receives an extension portion 37 such that a myriad of positions may be selected by an operator, who ultimately secures the clip receiving end 32 to the extension portion 37 via a manually rotated and tightened setscrew 38 with a threaded retaining portion 39 that ultimately engages the extension portion 37. The clip receiving end 32 and extraction end 14 may be repositioned after loosening the setscrew 38. A cap 41 having a threaded aperture (not depicted) for receiving a threaded end portion (not depicted) of the extension portion 37, is rotationally secured to the threaded end portion to prevent the clip receiving end 32 from sliding off the extension portion 37 when the setscrew 38 is loosened.

The alternative design allows the extraction end 14 to be adjustably disposed relative to the clip receiving end 32 a selected distance sufficient to allow the clip receiving end 32 to be grasped by an operator of the device 10, while the extraction end 14 grasps the end portion 20 of the clip 8 to ultimately remove the clip 8 from the hitch pin. Furthermore, the alternative design allows the clip receiving end 32 to be adjustably disposed relative to the extraction end 14 a selected distance sufficient to allow the extraction end 14 to be grasped by an operator of the device 10, while the clip receiving end 32 grasps the end portion 20 of the clip 8 to ultimately insert the clip 8 through and/or urge the clip 8 about the hitch pin. The alternative design provides optimum placement of the clip receiving end 32 so that the operator has the exact distance required between the clip receiving end 32 and the extraction end 14 to allow the operator to easily install or remove the clip 8 without injuring his or her hand.

In operation, an operator of the device 10 inserts a cotter pin or clip 8 partially into an aperture through a hitch pin that ultimately secures a trailer to a trailer hitch secured to a vehicle. The operator selects a device 10 with a longitudinal dimension sufficient to allow the operator to engage an end portion 20 of the clip 8 with a clip receiving end 12 of the device 10 while the operator holds the device 10 via an extraction end 14. The operator then forcibly inserts the clip 8 perpendicularly into the aperture of the hitch pin until a lineal first “leg” 40 of the clip 8 laterally “penetrates” the hitch pin, and such that an arcuate second leg 42 of the clip 8 engages a cylindrical outer portion of the hitch pin.

The operator ultimately removes the clip 8 grasping the clip receiving end 12 of the device 10, then “hooking” the end portion 20 of the clip 8 via the extraction end 14 of the device 10. The operator then forcibly pulls the clip 8 from the hitch pin, thereby allowing the hitch pin to be separated from the joined trailer and trailer hitch to allow the separation of the trailer from the pulling vehicle.

The foregoing description is for purposes of illustration only and is not intended to limit the scope of protection accorded this invention. The scope of protection is to be measured by the following claims, which should be interpreted as broadly as the inventive contribution permits.

1. A device for installing and removing a clip through or from a hitch pin comprising:
a clip receiving end for urging a clip through a hitch pin for a trailer hitch, said receiving end comprising:
an engagement portion configured to forcibly engage an end portion of the clip; and
means for maintaining engagement between said engagement portion and the end portion of the clip; and
an extraction end for removing the clip from the hitch pin, said extraction end being secured to said clip receiving end.

2. The device of claim 1 wherein said engagement portion includes an arcuate configuration that promotes engagement with an outer arcuate portion of the end portion of the clip.

3. The device of claim 1 wherein said engagement portion-includes a “V” configuration for engaging an outer portion of the end portion of the clip.

4. The device of claim 1 wherein said engagement portion includes a cylindrical configuration for engaging an outer portion of the end portion of the clip.

5. The device of claim 1 wherein said engagement portion includes a rectangular configuration for engaging an outer portion of the end portion of the clip.

6. The device of claim 1 wherein said engagement maintaining means includes opposite side plates secured to side portions of said engagement portion.

7. The device of claim 6 wherein said side plates are separated a predetermined distance sufficient to allow a predetermined end portion of a clip to snugly insert therebetween.

8. The device of claim 6 wherein said side plates include a predetermined surface area sufficient to maintain the position of the end portion of the clip relative to said engagement portion.

9. The device of claim 6 wherein said side plates include planar inner walls.

10. The device of claim 1 wherein said extraction end is distally disposed relative to said clip receiving end a distance sufficient to promote placement of said extraction end adjacent to the clip by the manipulation of said clip receiving end by the hand of an operator.

11. The device of claim 1 wherein said clip receiving end includes a handle configuration to promote the grasping of the clip receiving end by an operator of said device.

12. The device of claim 1 wherein said extraction end includes a handle configuration to promote the grasping of the extraction end by an operator of said device.

13. The device of claim 1 wherein said extraction end includes a hooked configuration.

14. The device of claim 1 wherein said extraction end includes an angular configuration.

15. The device of claim 1 wherein said extraction end is adjustably disposed relative to said clip receiving end a selected distance sufficient to allow said clip receiving end to be grasped by an operator of said device, while said extraction end grasps the end portion of the clip to ultimately remove the clip from a hitch pin.

16. The device of claim 16 wherein said clip receiving end is adjustably disposed via a set screw manually rotated to secure the position of said clip receiving end relative to said extraction end.

17. The device of claim 1 wherein said clip receiving end is adjustably disposed relative to said extraction end a selected distance sufficient to allow said extraction end to be grasped by an operator of said device, while said clip receiving end grasps the end portion of the clip to ultimately insert the clip through and/or urge the clip about a hitch pin.

18. A cotter pin insertion and removal device comprising:
means for inserting a cotter pin into a hitch pin;
means for removing the cotter pin from the hitch pin; and
means for adjustably positioning said insertion means relative to said removing means to allow an operator of said device to grasp said device while inserting or removing the cotter pin into or from the hitch pin.

19. The device of claim 18 wherein said adjustable positioning means includes a set screw for manually securing the position of said insertion means relative to said removing means.

20. A method for inserting and removing a cotter pin into or from a hitch pin, said method comprising the steps of:
providing means for receiving an end portion of the cotter pin whereby the cotter pin is ultimately urged into a hitch pin;
providing means for extracting an end portion of the cotter pin whereby the cotter pin is ultimately removed from a hitch pin;
providing means for manually grasping said receiving means whereby a user of the method is allowed to manually remove the cotter pin from the hitch pin; and
providing means for manually grasping said extracting means whereby a user of the method is allowed to manually insert the cotter pin into the hitch pin.
